(19) United States
(12) Patent Application Publication
(10) Pub. No.: US 2011/0216302 A1
(43) Pub. Date: Sep. 8, 2011

(54) ILLUMINATION METHODS AND DEVICES FOR PARTIALLY COHERENT ILLUMINATION

(75) Inventor: Jarek Luberek, Molndal (SE)

(73) Assignee: Micronic Laser Systems AB, Taby (SE)

(21) Appl. No.: 12/718,904

(22) Filed: Mar. 5, 2010

(51) Int. Cl. G03B 27/32; G02B 26/00

(52) U.S. Cl. 355/77; 359/237

(57) ABSTRACT

The technology disclosed relates to a partially coherent illuminators. In particular, it relates to a partially coherent illuminator that directs laser radiation across multiple areas of an illumination pupil. In some circumstances, this reduces spatial and/or temporal coherence of the laser radiation. It must be used with a continuous laser to provide partially coherent illumination from a coherent laser. It can be combined with a workpiece tracker that effectively freezes the workpiece and extends the time that laser radiation can be applied to expose a pattern stamp on the workpiece or, it can be used with a stepper platform, without a tracker. A dynamically controllable aperture architecture is a by product of the technology disclosed.

### BACKGROUND OF THE INVENTION

The technology disclosed relates to a partially coherent illuminators. In particular, it relates to a partially coherent illuminator that directs laser radiation across multiple areas of an illumination pupil. In some circumstances, this reduces spatial and/or temporal coherence of the laser radiation. It can be used with a continuous laser to provide partially coherent illumination from a coherent source. It can be combined with a workpiece tracker that effectively freezes the workpiece and extends the time that laser radiation can be applied to expose a pattern stamp on the workpiece or, it can be applied to a stepper, without a tracker. A dynamically controllable aperture architecture is a by product of the technology disclosed.

The Micronic Laser development team has pioneered a variety of platforms for microlithographic printing. An established platform for the Sigma machine is depicted in FIG. 1. A rotor printing platform described in recently filed patent applications is depicted in FIG. 2. A drum printing platform is described in other patent applications.

One printing mechanism designed for these platforms uses swept beams that are modulated as they traverse the surface of the workpiece, applying energy as a paintbrush applies color. Another printing mechanism design freezes the motion of the workpiece with the flash and stamps two dimensional patterns on the workpiece, exposing a radiation sensitive layer in a manner similar to block printing a pattern. Printing with stamps is an intricate process that typically includes overlap stamps and multiple writing passes.

Printing devices that apply stamps have typically used Excimer lasers that flash at a high rate. Special Excimer lasers have been developed that have partial coherence properties adapted to microlithographic printing. These lasers may be used to build illuminators and may be combined with homogenizer's to shape the beam and produce a desired illumination field.

Lasers are a major part of the operating cost of lithographic printing systems and especially Excimer lasers are excluded from low-cost direct write production applications due to too high operating costs. In these markets, lasers mode-locked to about one hundred MHz repetition rates or continuous wave lasers are made more cost effective. The opportunity arises to build an illuminator using these cost effective laser sources.

### SUMMARY OF THE INVENTION

The technology disclosed relates to a partially coherent illuminators. In particular, it relates to a partially coherent illuminator that directs laser radiation across multiple areas of an illumination pupil. In some circumstances, this reduces spatial and/or temporal coherence of the laser radiation. It must be used with a continuous laser to provide partially coherent illumination from a coherent laser. It can be combined with a workpiece tracker that effectively freezes the workpiece and extends the time that laser radiation can be applied to expose a pattern stamp on the workpiece or, it can be used with a stepper platform, without a tracker. A dynamically controllable aperture architecture is a by product of the technology disclosed. Particular aspects of the present invention are described in the claims, specification and drawings.

### BRIEF DESCRIPTION OF THE DRAWINGS

FIG. 1 depicts the general layout of an SLM pattern generator.

FIG. 2 depicts a scanning system with three arms and a pair of workpieces 211, 212 being written on opposite sides of the hub 248.

FIGS. 3-4 illustrate the illuminator and imaging parts of a system.

FIGS. 5a-5b illustrate scan patters for dipole and annular apertures.

FIG. 6 illustrates a tracking component on an arm that is reoriented on the rotor arm sweeps.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

We disclose, among a variety of methods and devices, how a mode-locked or continuous laser can be combined with one or two sets of electro-optical device in a illumination system and a projection system, to improve on the limited duty cycle of pulsed laser illumination sources, while providing partially coherent illumination of a MEMS object, SLM or mask. Some of the methods and systems disclosed also can be used with a pulsed laser.

Our technology relates to image generation and projection of a pattern onto a moving workpiece with a radiation-sensitive surface. This is sometimes called lithography or microlithography. We introduce a new approach to creating partially coherent illumination. This approach can be applied to a continuously moving or stepped workpiece. For a continuously moving workpiece, the new approach can be combined with workpiece tracking optics. Our technology supports use of continuous wave, long coherence length lasers, in combination with fast electro optical devices and stage synchronization.

A partially coherent imaging system that uses a two-dimensional image modulator typically delivers high resolution relative to numerical aperture and good focal depth, especially when used with advanced illumination techniques. A two-dimensional modulator illuminated with partially incoherent radiation can deliver performance that a purely incoherent Gaussian beam scanning cannot duplicate.

A shortcoming of typical 2D image projection systems is that short pulses are used to freeze the motion of the workpiece, which is positioned on a continuously moving stage. The modulators preferred for high capacity printing are relatively short along the scanning direction and wide in a direction orthogonal to the scanning. This keeps the size and MEMS degrees of freedom down, but it helps increase yield and reduce the cost of MEMS.

Another shortcoming of typical 2-D image projection systems is reliance on Excimer lasers to generate the required repetition rates. The expected repetition rate for an application such as direct write of TFT displays or packaging substrates, ranges between 20 kHz to 200 kHz. This pulse frequency is in the range of Q-switched lasers, which introduce further constraints in power output.

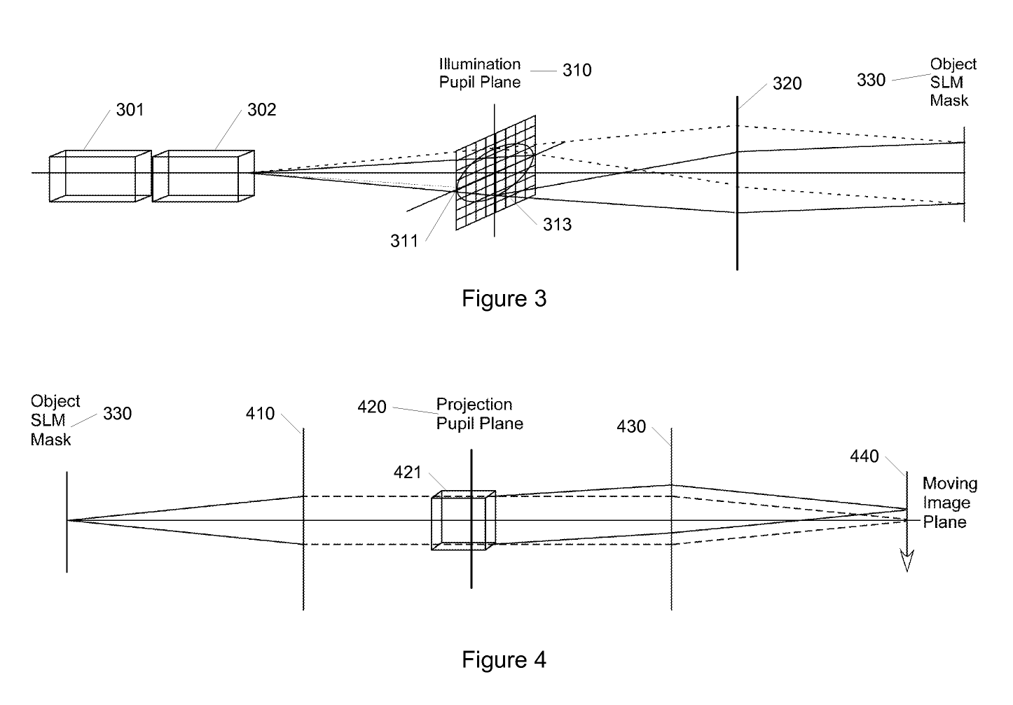

FIGS. 3-4 illustrate illuminator and imaging parts of our technology. The illuminator in FIG. 3 projects radiation onto an object 330, which may be a reflective or transmissive SLM or mask. A pair of electro-optical devices 301, 302 direct laser radiation along X and Y axes. These electro-optical devices operate at a very high speed. Devices that apply Pockels effect are appropriate for this application, but other high-speed electro-optical devices may be substituted. Two devices are indicated as devices applying Pockels effect are extremely fast but limited to control along one axis. If a deflector with two degrees of freedom is substituted, a single device could be used. In applications that require relatively slower devices, acousto-optical deflectors can be used. The deflected radiation is directed to areas 313 in an image pupil plane 310. A controller may direct the laser radiation in a pattern 311 to emulate a pupil. One or more lenses 320 direct laser radiation from the pupil onto the object 330. The same object 330 is repeated in the imaging part of the system depicted by FIG. 4. One or more lenses 410 direct modulated radiation from the object 330 to the projection pupil plane 420, where an electro-optical device 421 is positioned to track a workpiece 440 that is moving in the image plane, positioned on a stage. Operating requirements of the electro-optical device 421 are typically less demanding than for the pair of devices 301, 302. Accordingly, a slower device such as an acousto-optical deflectors can be used.

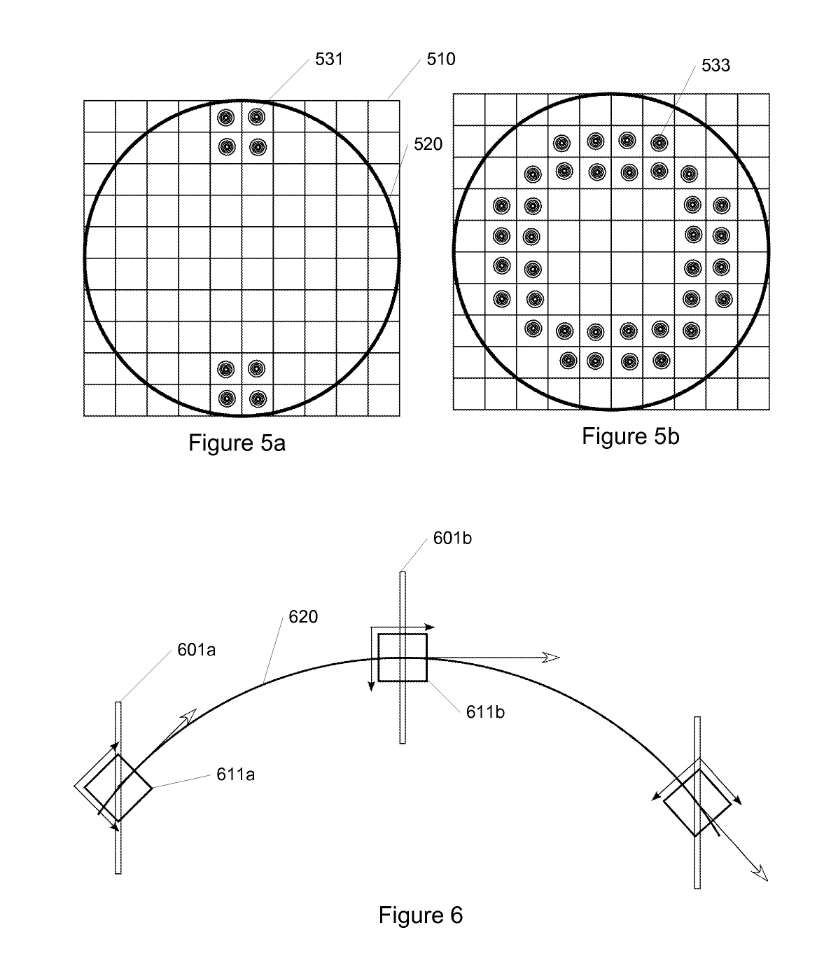

The electro-optical device 421 tracks the workpiece for a short time, corresponding to an exposure pulse. During this time, the workpiece will move less than or equal to the size of the projected stamp, so that the next stamp projected will overlap. In contrast, the electro-optics 301, 302 in the illumination system direct the laser radiation across the width and height of the pupil. Directing the laser radiation across this extent creates partial coherence from a fully coherent source, by repeatedly changing the path of the beam. The resulting partially coherent illumination has an effectively reduced temporal and/or spatial coherence. At the illumination pupil plane a plurality of micro-optical devices are positioned as targets for the directed laser radiation. These targets may be diffractive optical elements (DOEs) that process the laser radiation to illuminate the object 330 with the desired aspect ratio and homogeneity. This DOEs may be repeated in a grid of pupil positions. The pupil grid may, for instance, include 10×10 DOEs or more. Or, 50, 100 or more DOEs may be positioned to form an illumination pupil of a selected geometry, which need not be a grid. A controller coupled to the electro-optical deflectors directs the laser radiation to the DOEs or parts of the DOEs sequentially in time. Over time corresponding to the tracking time, the laser radiation is time modulated among the DOEs. A wide variety of pupil designs can be emulated by a selected timing and pattern of visiting DOEs. In FIG. 3, an oval pupil is depicted which is approximately 8×4 areas in size. This oval, a dipole (FIG. 5a), quad-pole, annulus (FIG. 5b), pair of pinholes, or virtually any desired aperture can be emulated with an appropriately chosen grid of DOEs and scanning pattern.

FIG. 5a illustrates a DOE grid and scan pattern 531, 510 for a dipole aperture.

The reference circle 520 is provided just for reference. FIG. 5b depicts the scan pattern 533 for an annular aperture. Not shown is the use of time division visiting the DOEs for differing times, to produce a tapered aperture. Any of the aperture designs listed above could potentially be tapered. The aperture design can be illuminated by electro-optically deflecting the laser beam during the time the image is projected in a fixed position on the workpiece. Of course, the time that the image is projected can be extended for a moving workpiece using the workpiece tracking device 421 described above.

Consider the following example. Suppose an image has a height of 25 microns when projected onto the workpiece. Suppose the workpiece is moving on a stage with a speed of 1 m/s. Then, the image can be exposed for up to 25 microseconds before the stage move further than the height of the image. The electro-optical scanner 421 tracks the workpiece for the 25 microseconds and effectively freezes the image in place for that long. During that time, the pair of electro-optical devices 301, 302 might translate the laser radiation among DOE elements with a period of 250 ns per element. In 25 microseconds, all 100 DOE elements in a 10×10 grid could be visited. Similarly, if a pulsed source were used, such as a mode-locked laser, the number of illuminated elements would be the pulse period divided by the element visit period.

Alternatively, this illuminator technology could be applied to a stepper platform, in which the workpiece is stationary during exposure. A continuous or high-frequency mode-locked laser could be used to reduce the operating cost of print and step devices.

At least two alternative electro-optical principles can be employed here. They include using an optical non-linearity such as the Pockels effect and using acousto-optical deflectors. It is possible to mix electro optic crystals in the illumination, where high speed is needed while the spot count is low, with an acousto-optic device in the projection system where the pixel count is high but repetition rate is well in the range of acousto-optical deflectors.

### Environments for 2D SLMs

In the following paragraphs, we describe two environments that use 2D SLM, which may benefit from use of the technology disclosed.

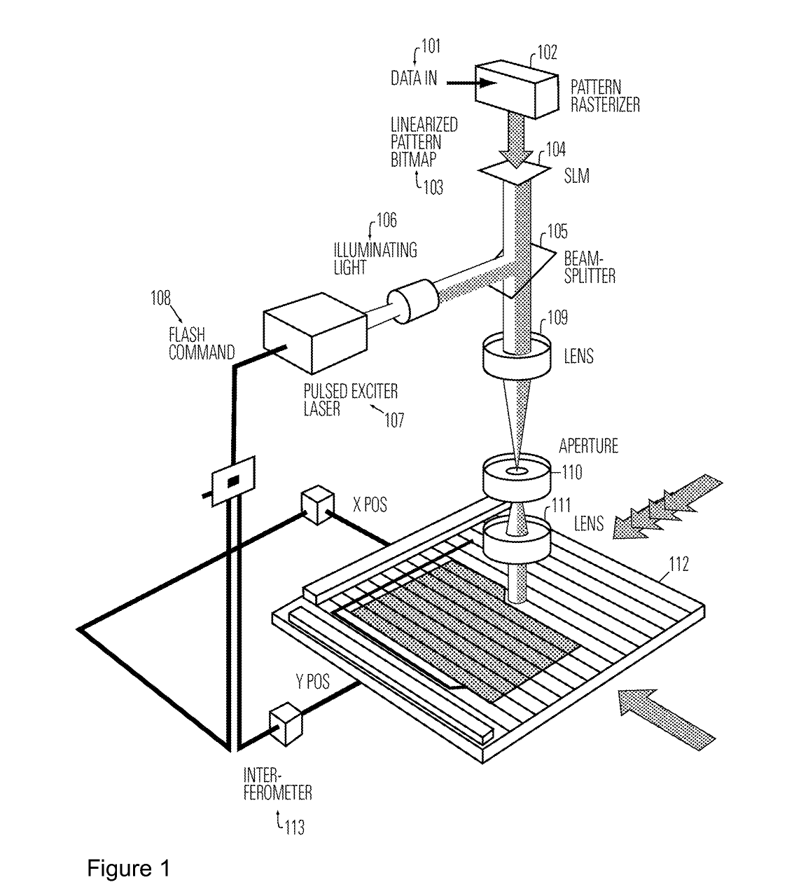

FIG. 1 depicts the general layout of an SLM pattern generator with a of xy stage. The workpiece to be exposed sits on a stage 112. The position of the stage is controlled by precise positioning device, such as paired interferometers 113.

The workpiece may be a mask with a layer of resist or other exposure sensitive material or, for direct writing, it may be an integrated circuit with a layer of resist or other exposure sensitive material. In the first direction, the stage moves continuously. In the other direction, generally perpendicular to the first direction, the stage either moves slowly or moves in steps, so that stripes of stamps are exposed on the workpiece. In this embodiment, a flash command 108 is received at a pulsed Excimer laser source 107, which generates a laser pulse. This laser pulse may be in the deep ultraviolet (DUV) or extreme ultraviolet (EUV) spectrum range. The laser pulse is converted into an illuminating light 106 by a beam conditioner or homogenizer. Applying the technology disclosed herein, a continuous laser with the illuminator described could be substituted for the pulsed laser, especially when with the workpiece tracking optics.

A beam splitter 105 directs at least a portion of the illuminating light to an SLM 104. The pulses are brief, such as only 20 ns long, so any stage movement is frozen during the flash. The SLM 104 is responsive to the datastream 101, which is processed by a pattern rasterizer 102. In one configuration, the SLM has 2048×512 mirrors that are 16×16 μm each and have a projected image of 80×80 nm. It includes a CMOS analog memory with a micro-mechanical mirror formed half a micron above each storage node.

The electrostatic forces between the storage nodes and the mirrors actuate the mirrors. The device works in diffraction mode, not specular reflectance, and needs to deflect the mirrors by only a quarter of the wavelength (62 nm at 248 nm) to go from the fully on-state to the fully off-state. To create a fine address grid the mirrors are driven to on, off and 63 intermediate values. The pattern is stitched together from millions of images of the SLM chip. Flashing and stitching proceed at a rate of 1000 stamps per second. To eliminate stitching and other errors, the pattern is written four times with offset grids and fields. Furthermore, the fields may be blended along the edges.

The mirrors are individually calibrated. A CCD camera, sensitive to the Excimer light, is placed in the optical path in a position equivalent to the image under the final lens. The SLM mirrors are driven through a sequence of known voltages and the response is measured by the camera. A calibration function is determined for each mirror, to be used for real-time correction of the grey-scale data during writing. In the data path, the vector format pattern is rasterized into grey-scale images, with grey levels corresponding to dose levels on the individual pixels in the four writing passes. This image can then be processed using image processing. The final step is to convert the image to drive voltages for the SLM. The image processing functions are done in real time using programmable logic. Through various steps that have been disclosed in the related patent applications, rasterizer pattern data is converted into values 103 that are used to drive the SLM 104.

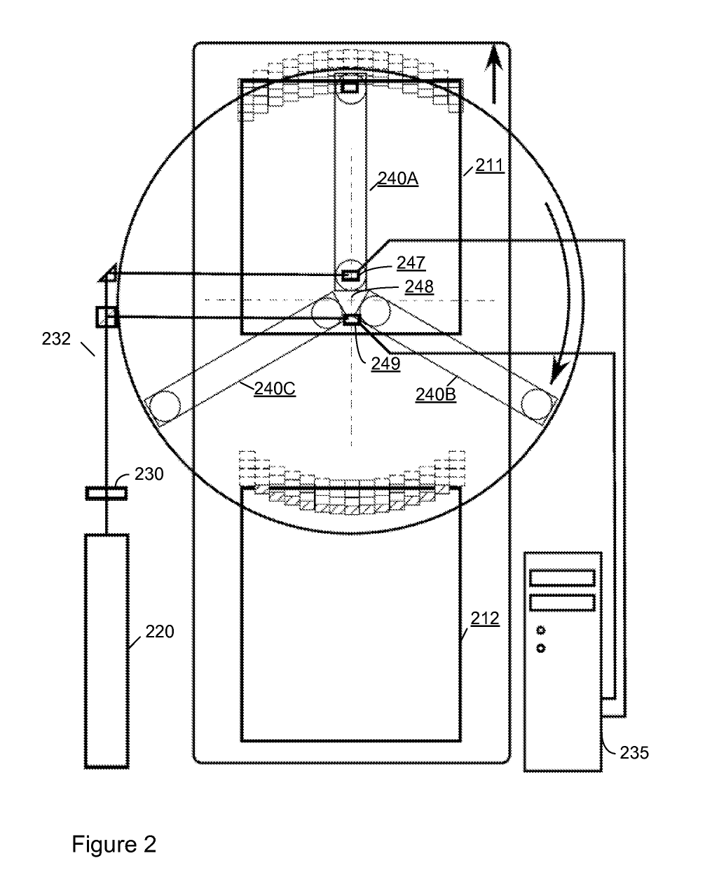

FIG. 2 depicts a rotor scanning system with three arms and a pair of workpieces 211, 212 being written on opposite sides of the hub 248. A rotary printer as depicted may print 2D images on the workpiece. This system may have a duty cycle of 100%. Each rotor writes through an arc of 60 degrees. Only one arm 240 writes at a time, alternatively on the two workpieces 211 and 212. The laser energy is switched by polarization control 232 between the two SLMs 247 and 249, and the data stream is also switched between the SLMs. Since the laser 220 and the data path 235 are among the most expensive modules in writing machines, this embodiment has been designed to use laser and data channel 100% of the time while the SLMs and the optics in the arms have lower duty cycles, 50% and 33% respectively. This may be, for instance, an example of a writing system with three rotating arms 240A-C. There are a variety of alternative designs for these arms and the relay optics. The figure conceptually depicts a laser 220 and a controller 235 sending data to two SLMs 230 which are relayed 232, 247, 249 to the rotating arms. It shows how each arm moves in front of each SLM and writes a series of concentric stamps on the workpieces 211, 212. While two workpieces are shown in this figure, more workpieces could be positioned under a rotor, depending on its size. While the example is described as a writing system, the direction of relay could just as easily be from the workpiece back to a pair of detectors positioned where the laser 220 is and elsewhere. In alternative configurations, one workpiece might be used; four arms might be used.

Some particularly useful applications of this technology involve writing patterns on electronic substrates, such as: wafers' front and back sides; PCBs; build-up, interposer and flexible interconnection substrates; and masks, stencils, templates and other masters. Likewise, the rotor writer can be used for patterning panels in displays, electronic paper, plastic logic and photovoltaic cells. The patterning can be done by exposure of photoresist, but also through other actions of light such as thermal or photochemical processes: melting, evaporation, ablation, thermal fusing, laser-induced pattern transfer, annealing, pyrolytic and photo induced etching and deposition.

This rotor system replaces the customary motion of a Cartesian flatbed xy stage with a polar scanning motion. Potential benefits include high throughput, low cost and mechanical simplicity. The scanning action is done by a rotating motion, which is mechanically easier to build to high accuracy than straight-line motion. The position accuracy of a point on the periphery of the rotor is determined by the quality of a bearing and the accuracy of an angle encoder. Both of these components can be sourced with high quality. A rotational reduces vibrations and transient forces during scanning and between scanning strokes. A well-balanced rotor emits essentially no vibrations or reactive forces to the supporting structure, while reciprocating straight movements need to reverse their momentum twice per stroke and create strong disturbances when doing so. A rotor may have a higher scanning velocity with less mechanical overhead. A rotor with several arms uses nearly the whole circle for writing. For instance, a rotor with four arms may scan through an 80 degree arc. Out of the 360 degrees in a circle, the rotor scans during 4×80=320 degrees. A reciprocating movement needs more mechanical overhead. The overhead for reciprocating movement gets larger with increased scanning velocity.

Rotor systems may have a very high data rate and throughput and may be used for other types of patterning where these characteristics are useful: photo-setting, printing, engraving, security marking, etc. The rotor has a smooth movement and small mechanical overhead even at high rotation speeds, e.g. 60, 120, 300, 600 r.p.m. or higher. The scanning speed, which is the peripheral speed of the rotor, may be higher than comparable reciprocating systems, e.g. 2, 4, 8, 20 m/s or higher.

In practical terms, one implementation would have a rotor one meter in diameter, spinning 3.3 turns per second with a centripetal acceleration of 20g. The acceleration force gives a constant force on rotating components, such that a lens weighing 50 grams will feel a constant force outwards of 10 N. With four arms and rotational speed, the system writes 13 strokes per second with a peripheral velocity of 10 m/s, a mechanical speed that is impractical with a reciprocating stage. Furthermore, with proper balancing and design of the bearings the motion will be smooth, have high mechanical precision and need little power to be sustained. If the image generator is a micromechanical 1D SLM with constant 2 MHz frame rate used for creating a 1D partial image on the workpiece, the reloading of the SLM would occur every 5 microns along the scanning direction and the pixel size could be 5×5 microns, allowing line width of less than 15 microns to be written. With a micromechanical 1D SLM, effectively having 8000×1 pixels, each stroke would fill a stripe 40 mm wide with pattern, and cover—with some reduction for the non-straight scan −0.3 square meters per second or 20 square meters per minute. This is a very high coverage rate, compared to other writing technologies.

FIG. 6 depicts a workpiece tractor mounted on a router arm. Although the projected image 601a, 601b maintains a substantially constant orientation, the tracking angle represented by an arrow continuously changes with the tangent of the curve 620. Mounting the tracker on the arm yields a continually correct orientation, but requires a separate tracker on each arm. Alternatively, the tracker could be positioned at the hub of the rotor system. One or more tractors could be positioned in the nonrotating portion of the optical path. The trackers could be rotated to match rotation of the active arm. A pair of trackers at right angles could service two pairs of arms. Or, a single tracker could rotate and snap to the correct position in between duty cycles of the arms. At the hub, a pair of electronic devices, such as 301, 302 could be coordinated to track in two dimensions. However, the geometry of the rotating arm system complicates use of the tracker in a hub position.

Alternatively, this technology may be usefully applied in an environment that uses a mask or reticle and a stepping stage.

### SOME PARTICULAR EMBODIMENTS

In some applications, the problem of speckle caused by laser pulses of short duration relative to their temporal coherence length can be solved by directing laser radiation, during an actual or emulated laser pulse, sequentially across multiple areas of an illumination pupil with separation among the multiple areas. This laser radiation optionally can be directed onto a modulator. The modulator can be either static, as a mask or reticle, or dynamic, as an SLM, SLV, DMD or similar device. The decreased coherence can have a decreased temporal and/or spatial coherence.

The solution to this problem can be enhanced by tracking a moving workpiece with a tracker that projects the laser radiation onto the workpiece in a constant position and effectively freezes motion of the workpiece for a extended time. It also can be enhanced by processing the laser radiation through diffractive optical elements positioned at the multiple areas. This diffractive optical elements may be a top hat elements that creates substantially uniform fields from the laser radiation.

In other applications, the problem of delivering a partially coherent illumination from a continuous laser with a long temporal coherence length can be solved by directing laser radiation from a continuous laser across multiple areas of an illumination pupil with separation among the multiple areas effective to decrease the coherence of the laser radiation.

In yet another application, the problem of providing adaptable aperture design for a lithographic exposure system is solved by directing laser radiation across multiple areas of an illumination pupil, dividing the time during which the laser radiation is directed to particular areas of the illumination pupil according to selected spatial and/or intensity distribution characteristics of the illumination pupil.

The technology disclosed can be practiced as any of a variety of methods or devices. The technology can be viewed from the perspective of replacing an intermittent laser source with the continuous laser source, effectively decreasing speckle from either a continuous or intermittent laser source, or fording dynamic flexibility to an illumination pupil.

One method that practices the technology supplies partially coherent laser illumination. This method includes directing laser radiation sequentially across multiple areas of an illumination pupil with separation among the multiple areas effective to decrease a coherence of the laser radiation

Optionally, this method includes directing laser radiation across multiple areas, to achieve a threshold number of degrees of freedom within a predetermined time. In this context, degrees of freedom is a measure of how many effectively different coherence patterns are produced by the illumination during the predetermined time. The more degrees of freedom present, the less speckle resulting from coherence effects when the illumination reaches an image plane. The impact of increasing the effective degrees of freedom of a partially coherent illumination source is further discussed by C. Rydberg et al., “Dynamic laser speckle has a detrimental phenomenon in optical projection lithography.” J. Microlith., Microfab., Microsyst. 5(3), 033004 (July-September 2006), which was authored by members of the same design team as the named inventor and which acknowledges the named inventor for insightful discussions on topics related to dynamic speckle. This article is hereby incorporated by reference.

According to one aspect of this technology, the threshold number of degrees of freedom is effective to reduce speckle. In some microlithographic applications, reduced speckle reduces line edge roughness resulting from the speckle.

In some embodiments, the method further includes using a continuous laser. Then, the laser radiation directs the beam of a continuous laser source. The continuous laser source may cycle across the areas of the illumination pupil in a predetermined time that emulates a pulse of a pulsed laser source.

Alternatively, the method can use a mode-locked, quasi-continuous laser. These quasi-continuous lasers operate at frequencies such as 100 MHz.

In some implementations, directing the laser radiation sequentially across the multiple areas decreases temporal and/or spatial coherence of the laser radiation.

In some implementations, a pair of electro-optical devices are used to direct the laser radiation. The devices may have orthogonally aligned axes. The electro-optical devices may utilize the so-called Pockels effect to redirect the laser radiation with extremely quick switching. When slower switching is acceptable, a wider range of devices can be used to direct the laser radiation, such as an acoustical optical deflector.

According to another aspect of this technology, the method may include processing the laser radiation through diffractive optical elements positioned at the multiple areas. The diffractive optical elements may apply a top hat filter or function that creates a substantially uniform field from the laser radiation.

In combination with the diffractive optical elements, the laser radiation may be redirected among the DOEs at least 25, 50 or 100 times during a time in which the modulator exposes or patterns a single area of a workpiece. The laser radiation may be redirected among the areas of the pupil with a period of about 500 ns or less, 250 ns or less, or 100 ns or less.

Some embodiments of this technology further include tracking a moving workpiece using an optical element that projects the laser radiation onto a workpiece and effectively freezes motion of the workpiece for a time. The time may be a relatively long time in which the laser radiation is directed to many areas of the illumination pupil. A wide range of electro-optical and acoustical optical devices can be used to track the movement. Depending on whether the movement is linear, as in a traditional xy bed with the graphic system or curvilinear, as in a rotor-based rating system, the tracking device may shift orientation or may be effective along multiple axes, as appropriate to the scanning geometry.

The technology disclosed may be used to produce a flexible and adaptive aperture, which can even be reconfigured dynamically or while a particular pattern is being written. The method described may further include dividing the time during which the laser radiation is directed to particular areas of the illumination pupil according to selected spatial and/or intensity distribution characteristics of the illumination pupil.

A variety of devices are adapted to practice the methods described above, applying any or all of the implementations, aspects, embodiments and alternatives described.

One device that practices the technology disclosed is an illuminator that supplies partially coherent laser illumination. The illuminator includes a laser radiation source. It further includes one or more optical deflectors in the optical path of the laser radiation and a controller coupled to the optical deflectors. This actuates the optical deflectors to sequentially scan the laser radiation across multiple areas of an illumination pupil, with separation among the multiple areas.

One aspect of this illuminator is that the controller sequentially scans the laser radiation across multiple areas, which is effective to achieve a threshold number of degrees of freedom within a predetermined time. This threshold is as described in the context of the methods above.

The threshold number of the degrees of freedom may be effective to reduce speckle. In some micro-lithographic applications, reduced line edge roughness follows from reduced speckle.

In some implementations, the laser radiation source is a continuous laser. The continuous laser source may cycle across the areas of the illumination pupil in a predetermined time that emulates a pulse of a pulsed laser source. In other implementations, it is a mode-locked, quasi-continuous laser. The laser radiation may be redirected to the areas and/or DOEs at a high rate or in a short period, subdividing a time in which the modulator exposes a workpiece.

In some circumstances, directing the laser radiation sequentially across the multiple areas decreases temporal and/or spatial coherence of the laser radiation.

Optionally, the illumination pupil further includes diffractive optical elements positioned at multiple areas. These diffractive optical elements may apply a top hat filter that creates a substantially uniform field from the laser radiation.

Another device that practices this technology is a system that incorporates the illuminator described above, optionally in combination with the various aspects, implementations and options described above, and further includes one or more second optical deflectors positioned in the optical path to track a workpiece, thereby effectively freezing motion of the workpiece for a time.

A further aspect of the illuminator includes the controller dividing the time during which the laser radiation is directed to particular areas of the illumination pupil according to selected spatial and/or intensity distribution characteristics of the illumination pupil.

We claim as follows:

1. A method of supplying partially coherent laser illumination, the method including:
directing laser radiation sequentially across multiple areas of an illumination pupil with separation among the multiple areas of the pupil and relaying the laser radiation on to a modulator from the multiple areas.

2. The method of claim 1, further including directing the laser radiation from a continuous laser source.

3. The method of claim 1, further including directing the laser radiation from a mode-locked quasi-continuous laser source.

4. The method of claim 1, further including decreasing temporal and/or spatial coherence of the laser radiation.

5. The method of claim 1, further including redirecting the laser radiation at least 50 times during a time in which the modulator is used to expose a single location on a workpiece.

6. The method of claim 1, further including processing the laser radiation through diffractive optical elements positioned at the multiple areas.

7. The method of claim 6, wherein the diffractive optical element applies a top hat filter that creates a substantially uniform field from the laser radiation.

8. The method of claim 1, wherein the laser radiation is directed across the multiple areas in a predetermined time that emulates a laser pulse.

9. The method of claim 1, further including tracking a moving workpiece with an optical element that projects the laser radiation, after modulation, onto a moving workpiece and effectively freezes the motion of the workpiece for a time.

10. The method of claim 1, further including dividing a time during which the laser radiation is directed to particular areas of the illumination pupil according to selected spatial characteristics of the illumination pupil.

11. The method of claim 1, further including dividing the time during which the laser radiation is directed to particular areas of the illumination pupil according to selected spatial and intensity distribution characteristics of the illumination pupil.

12. An illuminator that supplies partially coherent laser illumination to a modulator, the illuminator including:
a laser radiation source;
an optical path coupling the laser radiation source to a modulator;
an illumination pupil in the optical path;
one or more optical deflectors in an optical path of the laser radiation; and
a least one controller coupled to the optical deflectors that actuates the optical deflectors to sequentially scan the laser radiation across multiple areas of the illumination pupil, with separation among the multiple areas.

13. The illuminator of claim 12, wherein the sequential scanning of the laser radiation across multiple areas is effective to achieve a threshold number of degrees of freedom within a predetermined time.

14. The illuminator of claim 12, wherein the laser radiation source is a continuous laser.

15. The illuminator of claim 12, wherein the laser radiation source is a mode-locked quasi-continuous laser.

16. The illuminator of claim 12, wherein the sequentially scanning the laser radiation across the multiple areas of the illumination pupil decreases temporal coherence and/or spatial coherence of the laser radiation.

17. The illuminator of claim 12, wherein the illumination pupil further includes diffractive optical elements positioned at the multiple areas.

18. The illuminator of claim 17, wherein the diffractive optical elements apply a top hat filter that creates a substantially uniform field from the laser radiation.

19. A system including the illuminator of claim 12, and further including one or more second optical deflectors coupled to the controller and positioned in the second optical path that couples the modulator to a moving workpiece, wherein the controller activates the second optical deflectors to track a workpiece, thereby effectively freezing motion of the workpiece for a time.

20. The illuminator of claim 12, wherein the controller divides the time during which the laser radiation is directed to particular areas of the illumination pupil according to selected spatial and intensity distribution characteristics of the illumination pupil.
